(19) United States
(12) Patent Application Publication
(10) Pub. No.: US 2012/0205825 A1
(43) Pub. Date: Aug. 16, 2012

(54) MANUFACTURING METHOD FOR AN OPTICAL CONNECTOR

(75) Inventors: Akiko Nagafuji, Ibaraki-shi (JP); Naoyuki Matsuo, Ibaraki-shi (JP); Mayu Shimoda, Ibaraki-shi (JP)

(73) Assignee: NITTO DENKO CORPORATION, Osaka (JP)

(21) Appl. No.: 13/346,125

(22) Filed: Jan. 9, 2012

(30) Foreign Application Priority Data
Feb. 10, 2011 (JP) 2011-027911

(51) Int. Cl. G02B 6/26

(52) U.S. Cl. 264/1.25

(57) ABSTRACT

Provided is a cost-effective manufacturing method for an optical connector, which enables an optical waveguide to be fixed to a ferrule easily in a short period of time. A manufacturing method for an optical connector includes: fitting an end portion of a transparent optical waveguide into an optical waveguide fitting groove of an optical connection ferrule made of a resin; and fusing and fixing the end portion of the transparent optical waveguide to the optical connection ferrule by applying a laser beam having a predetermined wavelength downward from above the optical waveguide fitting groove toward the transparent optical waveguide, so that the laser beam reaches a bottom surface of the optical waveguide fitting groove.

### BACKGROUND OF THE INVENTION

1. Field of the Invention

The present invention relates to a manufacturing method for an optical connector, which is obtained by integrally mounting an optical connection ferrule, such as a PMT ferrule, to a leading end portion of an optical waveguide.

2. Description of the Related Art

In recent years, integration and increase in scale of electronic devices have raised problems of heat generation and increased power consumption of electric wiring, which is widely used for connection between boards or chips on a board in the device. Therefore, there has been developed an optical wiring (optical interconnection) technology, in which such electric wiring is replaced with a lightweight, flexible polymer optical waveguide which generates a smaller amount of heat (see Japanese Patent Application Laid-open Nos. Hei 10-186187 and 2000-2820).

An optical connector (optical waveguide connector) to be used in the optical wiring for connection between the respective boards or the like includes a band-like optical waveguide, and a connection terminal having a predetermined shape called “ferrule”, which is mounted to a longitudinal end portion (terminal end) of the optical waveguide. Further, using a positional alignment function with a guide pin between the ferrules placed to be opposed to each other, the optical connector connects (optically connects) between an optical fiber and the optical waveguide, or between one optical waveguide and another optical waveguide, to thereby transmit signals and the like between the respective boards. Note that standardization of the shape, dimension, and test method of the optical connector (PMT ferrule) has progressed in conformity with JIS and the like, and the manner of alignment connection between the optical connectors is also unified. Thus, the optical connector can be connected to another connector easily (see, for example, JPCA Standards “Detail Specification for PMT Connector” JPCA-PE03-01-07S-(2006), Japan Electronics Packaging and Circuits Association, May 2006).

In a case of assembling such an optical connector, for example, when mounting a general-purpose PMT ferrule or the like to an end portion of the optical waveguide, the end portion of the optical waveguide is fitted into an optical waveguide fitting groove (through-groove) formed in an upper surface of a PMT ferrule main body, and after the position of the above-mentioned optical waveguide is aligned in the groove so that the end portion (end surface) of the optical waveguide is exposed from (becomes flush with) a leading end surface of a ferrule main body, the end portion is fixed with a fixing agent such as an ultraviolet curable adhesive. Then, a PMT lid for covering an upper portion of the groove of the above-mentioned ferrule main body, a PMT boot for protecting the optical waveguide, and the like are mounted with an adhesive similar to the above-mentioned adhesive, and as a result, the optical connector is completed (see Japanese Patent Application Laid-open No. 2009-282168).

Note that the optical connector produced as described above cannot directly be put into use in many cases because an excessive portion of the above-mentioned used adhesive or the like projects as a “blur” at the leading end surface (optical connection surface) of the optical connector, and because the above-mentioned adhesive or the like adheres to the end surface of the optical waveguide exposed at the leading end surface. Therefore, after the optical waveguide is fixed, there is generally performed a polishing step of polishing the leading end surface (optical connection surface) of the above-mentioned optical connector to a right angle.

However, as described above, the conventional manufacturing method for an optical connector, in which the optical waveguide is fixed with a fixing agent such as an adhesive, requires material cost for the fixing agent, and time and labor for fixing work (increases the number of steps). Further, the polishing step needs to be performed after the optical waveguide is fixed, which leads to a problem of an increase in cost. Therefore, a solution to such a problem is demanded.

### SUMMARY OF THE INVENTION

A cost-effective manufacturing method for an optical connector is provided, which enables an optical waveguide to be fixed to a ferrule easily in a short period of time.

A manufacturing method for an optical connector is provided, including: fitting an end portion of a transparent optical waveguide, which includes a core and cladding layers provided above and below the core, into an optical waveguide fitting groove formed at a predetermined position of an optical connection ferrule made of a resin; and fusing and fixing the transparent optical waveguide to the optical connection ferrule by applying a laser beam having a predetermined wavelength downward from above the optical waveguide fitting groove toward the transparent optical waveguide so that the laser beam reaches a bottom surface of the optical waveguide fitting groove.

Specifically disclosed is a method of fixing the optical waveguide to the optical connection ferrule made of a resin without using the adhesive or the like. That is, the optical waveguide can be fixed quickly and easily without any adverse effect on the dimensional accuracy and performance of the optical waveguide when an interface portion between the optical waveguide and the ferrule opposed thereto is heated and fused utilizing a laser beam in a wavelength range in which the laser beam is not absorbed by the material that forms the optical waveguide (near infrared range).

Note that the term “transparency” or “transparent” is a concept including, for example, a completely transparent state and a semi-transparent state like a frosted glass. Specifically, the “transparent” state refers to a state of transmittance of 90% or higher with respect to the wavelength of the laser beam.

As described above, in the manufacturing method for an optical connector, in the state in which the end portion of the transparent optical waveguide is fitted into the optical waveguide fitting groove of the optical connection ferrule made of a resin, the laser beam having the predetermined wavelength is applied from above the fitting groove (opening side) to the bottom surface of the above-mentioned fitting groove through the above-mentioned optical waveguide. As a result, the above-mentioned optical waveguide can be fused and fixed to the fitting groove of the ferrule quickly and easily utilizing the heat generation due to the absorption of the laser beam.

Further, in the manufacturing method for an optical connector, the above-mentioned laser beam passes through the optical waveguide without being absorbed by the optical waveguide, and hence no adverse effect is imposed on the dimensional accuracy and performance of the optical waveguide. Moreover, the heat is not directly applied to the optical waveguide, and hence, during the fixing work, the position thereof (aligned position) is not shifted. Further, the adhesive or the like is not used, and hence there occurs no positional shift due to, for example, contraction at the time of curing the adhesive. Accordingly, the manufacturing method for an optical connector enables precise and accurate fixing of the end portion of the optical waveguide to the predetermined position in the fitting groove of the above-mentioned ferrule.

Further, it is only necessary to use the minimal amount of the fixing adhesive or the like merely for the temporary fixing, and hence no blur or smear from the adhesive or the like is generated in the leading end surface of the ferrule. Thus, the manufacturing method for an optical connector has such advantages that the cost for the above-mentioned fixing agent can be reduced and the polishing step after the optical waveguide is fixed can be omitted.

Further, in the manufacturing method for an optical connector, in a case where the laser beam to be used for fixing the above-mentioned optical waveguide is a near infrared laser beam having a wavelength of from 800 nm to 2,000 nm, which is not easily absorbed particularly by the optical waveguide, it is possible to further suppress the adverse effect on the dimensional accuracy and performance of the optical waveguide, and to selectively and efficiently heat the bottom surface (interface between the ferrule and the optical waveguide) of the fitting groove of the above-mentioned optical connection ferrule made of a resin.

### BRIEF DESCRIPTION OF THE DRAWINGS

In the accompanying drawings:

FIG. 1 is an exploded perspective view illustrating a method of assembling an optical connector according to a first embodiment;

FIGS. 2A to 2C are schematic sectional views illustrating a manufacturing method for an optical connector according to the first embodiment; and

FIG. 3 is a schematic sectional view illustrating a structure of an opto-electric hybrid module using the optical connector.

### DETAILED DESCRIPTION OF THE INVENTION

Next, referring to the accompanying drawings, embodiments of the present invention are described in detail.

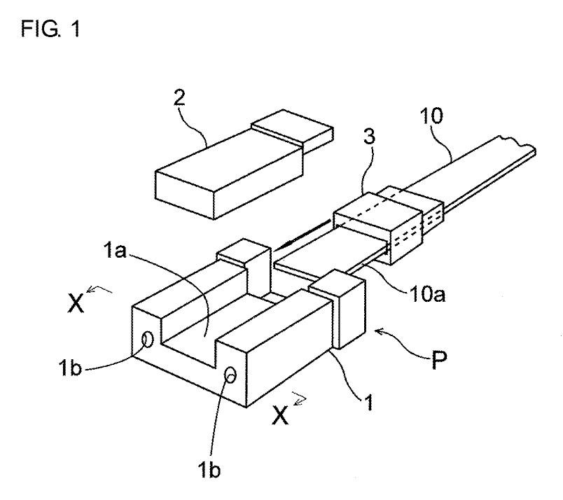

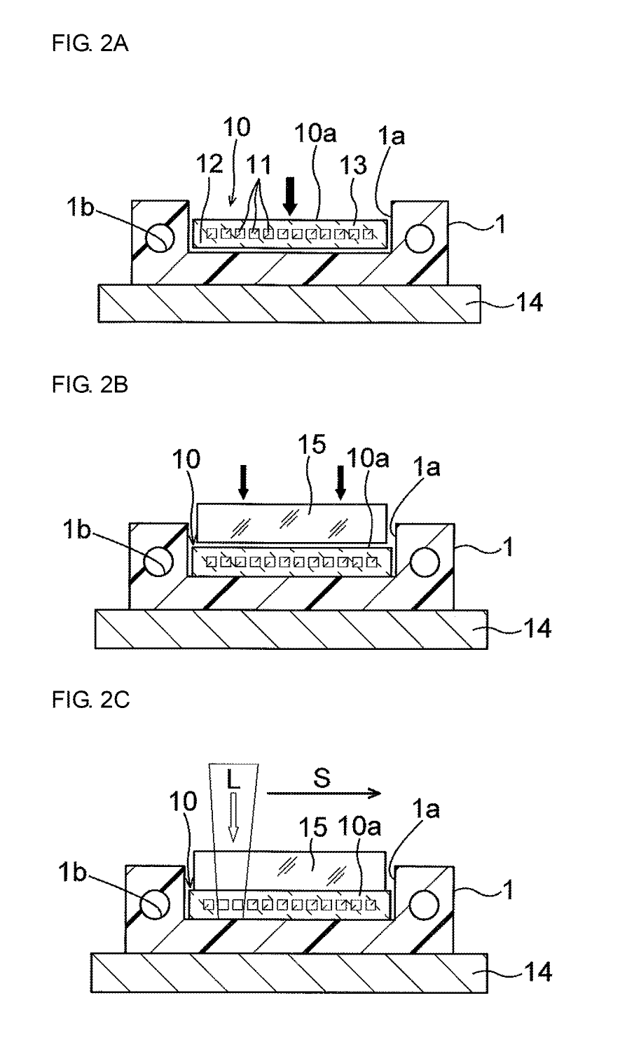

As illustrated in FIG. 1, an optical connector according to a first embodiment is constructed by mounting a PMT ferrule (reference symbol P), which includes a ferrule main body 1, a lid 2, and a boot 3, to an end portion 10a of a film-like transparent polymer optical waveguide 10. Further, in the optical connector, the above-mentioned polymer optical waveguide 10 is fixed to the ferrule main body 1 in the following manner. That is, in a state in which the end portion 10a of the above-mentioned polymer optical waveguide 10 is, as illustrated in FIG. 2A, fitted into an optical waveguide fitting groove (through-groove) 1a formed in an upper surface of the ferrule main body 1, and is aligned at a predetermined position (see FIG. 2B), a laser beam having a predetermined wavelength is applied from above an opening side of the above-mentioned fitting groove 1a so that the laser beam reaches a bottom surface of the fitting groove 1a (see FIG. 2C). Accordingly, the bottom surface of the fitting groove 1a is melted, and the end portion 10a of the above-mentioned optical waveguide 10 is firmly fixed to the above-mentioned ferrule main body 1.

The above-mentioned manufacturing method for an optical connector is described in more detail. FIGS. 2A to 2C are schematic sectional views illustrating the manufacturing method for an optical connector according to the first embodiment. In FIGS. 2A to 2C, the cross section of the ferrule main body 1 and the optical waveguide 10 corresponds to the X-X cross section of FIG. 1.

The manufacturing method for an optical connector according to this embodiment includes the steps of: preparing a transparent (light transmissive) polymer optical waveguide 10; preparing an opaque (non-light transmissive) ferrule main body 1 (PMT ferrule P) having an optical waveguide fitting groove 1a; fitting an end portion 10a of the above-mentioned polymer optical waveguide 10 into the optical waveguide fitting groove 1a of the ferrule main body 1 (Step A: see FIG. 2A); temporarily fixing the above-mentioned end portion 10a in a state in which a position of the end portion 10a of the polymer optical waveguide 10 is adjusted for positional alignment thereof (Step B: see FIG. 2B); and fully fixing the end portion 10a of the above-mentioned optical waveguide 10 to a bottom surface of the fitting groove 1a by applying a laser beam L from above the above-mentioned optical waveguide fitting groove 1a to the bottom surface of the fitting groove 1a through the optical waveguide 10 (Step C: see FIG. 2C).

In the above-mentioned step of “preparing a polymer optical waveguide 10”, as illustrated in FIGS. 2A to 2C, there is prepared a film-like flexible optical waveguide 10 made of a transparent resin, which includes a plurality of (in this embodiment, twelve) cores 11 extending in a longitudinal direction (front-back direction of the drawing sheet), and an undercladding layer 12 and an overcladding layer 13 provided above and below the cores 11 so as to sandwich the cores 11.

The above-mentioned transparent polymer optical waveguide 10 may be formed by a method of patterning the cores 11 through photolithography or the like using an ultraviolet curable resin such as an epoxy resin. Further, the above-mentioned polymer optical waveguide 10 is designed in such a manner that the refractive index (optical refractive index) of the cores 11 is higher than the refractive index of the above-mentioned undercladding layer 12 and overcladding layer 13 so that an optical signal entering the cores 11 may be transmitted in the longitudinal direction thereof.

Note that, as a standard dimension of the above-mentioned polymer optical waveguide 10, the following preferable dimensions are provided. That is, the overall width ranges from 2.970 mm to 3.000 mm; the overall thickness, 0.1 mm to 0.2 mm; the width and height (thickness) of each core 11, 0.040±0.005 mm; and the pitch of the cores 11, 250 μm (see “Annex A” of JPCA Standards “Detail Specification for PMT Connector” JPCA-PE03-01-07S-(2006), Japan Electronics Packaging and Circuits Association, May 2006).

Further, in the above-mentioned step of “preparing a ferrule main body 1 (PMT ferrule P)”, an opaque ferrule main body 1 made of a resin is prepared. The opaque ferrule main body 1 may be formed by transfer molding, molding, injection molding, or the like using a non-light transmissive resin or a hyperchromic or black non-light transmissive resin obtained by adding dye such as pigment or extender such as titanium to a light transmissive resin.

Further, as illustrated in FIGS. 2A to 2C, in the upper surface of the above-mentioned ferrule main body 1, there is provided a fitting groove 1a (preferable width in the longitudinal direction: 3.000 mm to 3.010 mm) capable of receiving the polymer optical waveguide 10 having the above-mentioned preferable width. In a leading end surface of the ferrule main body 1, there are formed guide pin holes 1b and 1b for inserting guide pins (not shown) therethrough. Note that, the lid 2 and the boot 3 to be assembled to the above-mentioned ferrule main body 1 may be transparent or opaque. Further, the dimension of each of the lid 2 and the boot 3 may conform to the standard of JPCA Standards “Detail Specification for PMT Connector” JPCA-PE03-01-07S-(2006), Japan Electronics Packaging and Circuits Association, May 2006, which is described above.

Subsequently, when the above-mentioned polymer optical waveguide 10 is fixed to the ferrule main body 1, as illustrated in FIG. 2A, the ferrule main body 1 is first placed on a plate-like stage 14 or the like, and the end portion 10a of the above-mentioned polymer optical waveguide 10 is fitted into the optical waveguide fitting groove 1a of the ferrule main body 1 (Step A).

Then, the end portion 10a of the above-mentioned optical waveguide 10, an alignment mark formed in advance, and the like are recognized with an image apparatus (not shown) using an optical microscope or a camera, for example. Based on information thereon, the position of the end portion 10a of the polymer optical waveguide 10 is adjusted so that the end surface of the end portion 10a of the polymer optical waveguide 10 and the leading end surface of the ferrule main body 1 become substantially flush with each other.

Subsequently, in order to prevent the end portion 10a of the polymer optical waveguide 10, which is aligned at the predetermined position, from being shifted due to vibration or the like in the course of the subsequent steps, as illustrated in FIG. 2B, the above-mentioned end portion 10a is temporarily fixed to a desired position by pressing the end portion 10a against the bottom surface of the fitting groove 1a using a heavy load (hard object) such as a glass plate 15 (Step B). Note that, at the time of positional alignment or temporary fixing, a small amount of an adhesive or the like for temporary fixing may be applied in advance between the end portion 10a of the above-mentioned optical waveguide 10 and the bottom surface of the fitting groove 1a of the ferrule main body 1.

Then, as illustrated in FIG. 2C, the end portion 10a of the above-mentioned optical waveguide 10 is fully fixed to the bottom surface of the fitting groove 1a by applying, at the end portion 10a of the optical waveguide 10 with its position temporarily fixed as described above, the laser beam L from above the optical waveguide fitting groove 1a to the bottom surface of the fitting groove 1a through (via) the optical waveguide 10 (Step C).

As illustrated in FIG. 2C, the above-mentioned laser beam L basically has a focal point adjusted at the bottom surface of the above-mentioned fitting groove 1a or below the bottom surface (on the inner side of the ferrule main body 1). Accordingly, only the bottom surface (front surface) of the above-mentioned fitting groove 1a is heated and fused selectively and efficiently without any adverse effect on the optical waveguide 10. Further, by scanning the laser beam having the focal point set as described above in the width direction (arrow S direction) of the above-mentioned optical waveguide 10, the bottom surface of the above-mentioned fitting groove 1a is sequentially heated through the overall width thereof, and sequentially from the position of the bottom surface that is cooled and set, the end portion 10a of the above-mentioned optical waveguide 10 and the bottom surface of the fitting groove 1a of the ferrule main body 1 are firmly fixed to each other. Note that the focal point of the above-mentioned laser beam L is not necessarily coincident with the bottom surface of the fitting groove 1a (interface between the ferrule main body 1 and the optical waveguide 10), and even if the focal point is situated slightly forward or backward, sufficient energy for forming a junction is obtainable due to the expansion of the laser beam L.

Further, as the laser beam to be used for fully fixing the above-mentioned optical waveguide 10, a near infrared laser beam having a wavelength of from 800 nm to 2,000 nm may suitably be used. This is because the laser beam having the above-mentioned wavelength is not easily absorbed by the material (ultraviolet curable resin) used for the optical waveguide 10 (cores 11, undercladding layer 12, and overcladding layer 13) so that the adverse effect of heat or the like on the above-mentioned optical waveguide 10 may further be reduced. In addition, the near infrared laser beam having the wavelength of from 800 nm to 2,000 nm is effectively absorbed by the surface of the hyperchromic or black ferrule main body 1, and produces an effect of promoting the fusing of the surface.

With the above-mentioned structure, the manufacturing method for an optical connector according to this embodiment enables easy and quick fixing of the end portion 10a of the above-mentioned optical waveguide 10 to the fitting groove 1a of the ferrule main body 1 utilizing the energy of the above-mentioned laser beam. Further, in the manufacturing method for an optical connector, heat is not applied to the optical waveguide 10, and hence, during the fixing work, the aligned position is not shifted. Accordingly, the manufacturing method for an optical connector according to this embodiment enables precise and accurate fixing of the end portion 10a of the optical waveguide 10 to the predetermined position in the fitting groove 1a of the ferrule main body 1.

Besides, in the manufacturing method for an optical connector, only a minimal amount of an adhesive is used merely for the temporary fixing, and hence no blur or smear from the adhesive is generated in the leading end surface of the ferrule main body 1. Thus, the manufacturing method for an optical connector according to this embodiment may omit the conventionally needed polishing step after the optical waveguide is fixed.

Note that, in the above-mentioned embodiment, only one end portion of the optical connector is described, but the above-mentioned PMT ferrule P may be mounted to one of the endportions of the optical waveguide or to both ends thereof.

Next, a second embodiment is described.

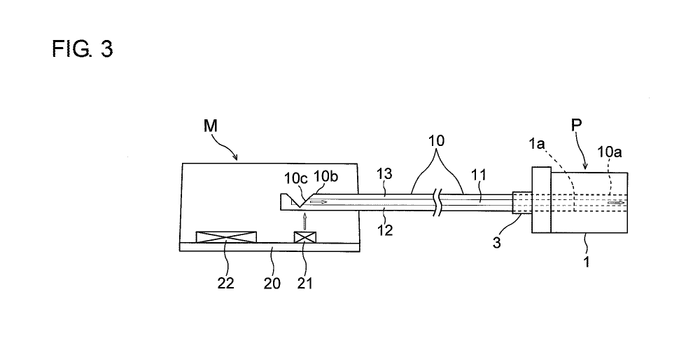

FIG. 3 is a schematic sectional view illustrating a structure of an opto-electric hybrid module using the optical connector.

An opto-electric hybrid module M with an optical connector illustrated in FIG. 3 includes an optical path conversion unit 10c including a semi-transparent mirror, which is provided to one end portion 10b of the optical waveguide 10 of the optical connector according to the above-mentioned first embodiment. In this structure, the optical path conversion unit 10c is mounted onto an opto-electric hybrid circuit board 20 including an electric circuit, a light emitting element, and a light receiving element. Note that, in FIG. 3, reference numeral 21 represents a photoelectric conversion unit integrally including a light emitting element such as a VCSEL and a light receiving element such as a PD, and reference numeral 22 represents an IC chip such as a driver and a TIA. Other electric components mounted on the opto-electric hybrid circuit board 20 are omitted from FIG. 3.

Also in this embodiment, the manufacturing method for the optical connector part (PMT ferrule 2) is similar to that of the first embodiment. Specifically, the optical connector is manufactured by the method involving: preparing a transparent optical waveguide 10 and an opaque ferrule main body 1 having an optical waveguide fitting groove 1a; fitting an end portion 10a of the optical waveguide 10 into the above-mentioned fitting groove 1a (see FIG. 2A); temporarily fixing the end portion 10a in a state in which a position of the end portion 10a is adjusted for positional alignment thereof (see FIG. 25); and fully fixing the end portion 10a of the above-mentioned optical waveguide 10 to a bottom surface of the fitting groove 1a by applying a laser beam L from above the above-mentioned optical waveguide fitting groove 1a to the bottom surface of the fitting groove 1a through the optical waveguide 10 (see FIG. 2C).

Subsequently, the lid 2, the boot 3, and the like of the ferrule are mounted. After the above-mentioned PMT ferrule P is mounted to the one end portion 10a of the optical waveguide 10, the optical path conversion unit 10c (semi-transparent mirror) is provided to the another end portion 10b of the optical waveguide 10 through dicing or the like. After that, as illustrated in FIG. 3, the optical path conversion unit 10c is mounted and fixed above the photoelectric conversion unit 21 of the opto-electric hybrid circuit board 20.

Also in such an opto-electric hybrid module M with an optical connector, the above-mentioned optical connector part (PMT ferrule P) can be fixed quickly and easily to the end portion 10a of the optical waveguide 10 utilizing the energy of the laser beam. Further, heat is not applied to the above-mentioned optical waveguide 10 during the fixing work therefor, and hence the position aligned on the ferrule main body 1 is not shifted. Accordingly, in the opto-electric hybrid module M1 with an optical connector according to this embodiment, the optical connector (PMT ferrule P) thereof can be optically connected to another optical connector with a low coupling loss.

Note that, as a forming material to be used for manufacturing the optical waveguide for an optical connector according to the above-mentioned first and second embodiments, a photosensitive resin (photopolymerized resin) such as an oxetane resin and a silicone resin as well as an epoxy resin, a polyimide resin, an acrylic resin, a methacrylic resin may be used for both the cladding layers and the cores. The photopolymerized resins form a photopolymerized resin composition together with a photocatalyst such as a photoacid generator, a photobase generator, and a photoradical polymerization initiator, and may include a reactive oligomer, a diluent, a coupling agent, and the like as other components.

Further, the optical waveguide to be used in the manufacturing method for an optical connector may be an optical waveguide having another structure than the polymer optical waveguide, such as an optical waveguide made of glass, as long as the optical waveguide is flexible and allows light in a near infrared range to pass therethrough at high rate. Further, the manufacturing method therefor is also selectable as appropriate. Note that the optical waveguide to be used needs to be determined in consideration of affinity (adhesiveness) with a resin that forms the PMT ferrule.

### EXAMPLES

Next, an example is described together with a comparative example. Note that, the present invention is not limited to the following example.

In this example, a polymer optical waveguide was manufactured through photolithography, and one end portion of the polymer optical waveguide was fixed to a commercial PMT ferrule using a near infrared laser beam. Further, the same optical waveguide was used and the end portion thereof was fixed to the PMT ferrule with an adhesive to manufacture a comparative example of the optical connector. The example and the comparative example were compared to each other on an insertion loss “before mounting the ferrule” and an insertion loss “after mounting the ferrule” (in the comparative example, after carrying out polishing). Note that, the insertion loss was measured in conformity with JIS C 5961 “test method for optical fiber connector”.

In advance of the example, an optical waveguide for the test was first manufactured.

### <Manufacture of Optical Waveguide>

### [Forming Material for Cladding Layers]

| | |
|---|---|
| Component A: epoxy resin including an alicyclic | 100 parts by weight |
| skeleton <produced by ADEKA | |
| CORPORATION: EP4080E> | |
| Component B: (photoacid generator) | 2 parts by weight |
| triarylsulfonium salt, 50% solution in propylene | |
| carbonate <produced by San-Apro Ltd.: CPI-200K> | |

Those components were mixed and agitated to prepare a forming material (photopolymerized resin composition) for an undercladding layer and an overcladding layer.

[Forming Material for Cores]

| | |
|---|---|
| Component C: epoxy resin including a fluorene | 40 parts by weight |
| skeleton <produced by Osaka Gas Chemicals | |
| Co., Ltd.: OGSOL EG> | |
| Component D: epoxy resin including a fluorene | 30 parts by weight |
| skeleton <produced by Nagase ChemteX | |
| Corporation: EX-1040> | |
| Component E: oxetane resin <produced | 30 parts by weight |
| by NITTO DENKO CORPORATION: 1,3,3-tris(4- | |
| (2-(3-oxetanyl)butoxyphenyl)butane)> | |
| Component B: (photoacid generator) | 1 part by weight |
| triarylsulfonium salt, 50% solution in propylene | |
| carbonate <produced by San-Apro Ltd.: CPI-200K> | |

Those components were agitated and dissolved in 71 parts by weight of ethyl lactate (produced by Musashino Chemical Laboratory, Ltd.) to prepare a forming material (photopolymerized resin composition) for cores.

[Manufacture of Undercladding Layer]

First, the forming material for the above-mentioned cladding layers was applied to a surface of a polyethylene naphthalate (PEN) film (0.188 mm thick and 150 mm per side) using an applicator, and an ultraviolet ray of 1,000 mJ/cm² was applied to the entire surface. Then, heating treatment was performed at 80° C. for 5 minutes, and an undercladding layer was formed on a base material. The thickness of the obtained undercladding layer was 25 μm when measured with a contact thickness meter. Note that a refractive index of the undercladding layer (forming material) at 830 nm is 1.510.

[Manufacture of Cores]

Subsequently, the forming material for the cores was applied to a surface of the above-mentioned undercladding layer using the applicator, and then drying treatment was performed at 100° C. for 5 minutes. Subsequently, a quartz-based chromium mask (photomask) having openings in a pattern corresponding to the straight cores parallel to one another along the longitudinal direction (12 cores, core width/core interval=50 μm/200 μm) was disposed on the forming material (layer) for the above-mentioned cores, and exposure through application of an ultraviolet ray of 2,500 mJ/cm² was performed from thereabove by a proximity exposure method (gap: 100 μm) through an i-bandpass filter.

Then, heating treatment was performed at 100° C. for 10 minutes. Subsequently, dipping development was performed using γ-butyrolactone (produced by Mitsubishi Chemical Corporation) to dissolve and remove an unexposed portion, and then heating and drying treatment was performed. As a result, cores having the above-mentioned patterned shape were formed. A sectional dimension of each obtained core was measured with a digital microscope, with the result that the width was 50 μm and the height (thickness) was 50 μm. Note that, as in the JPCA standards, the center of each core having the substantially square shape is positioned in height 0.050±0.003 mm away from the bottom surface of the undercladding layer (bottom surface of the entire optical waveguide). Further, a refractive index of the core (forming material) at 830 nm was 1.592.

[Manufacture of Overcladding Layer]

First, the forming material for the above-mentioned cladding layers was applied so as to cover the above-mentioned cores using an applicator, and an ultraviolet ray of 1,000 mJ/cm² was applied to the entire surface. Then, heating treatment was performed at 80° C. for 5 minutes, and an overcladding layer covering the above-mentioned cores was formed on the undercladding layer. The thickness of the obtained overcladding layer of the optical waveguide was 25 μm when measured with a digital microscope. Note that a refractive index of the overcladding layer (forming material) at 830 nm is 1.510.

[Manufacture of Strip-Like Optical Waveguide]

The film-like optical waveguide thus manufactured was cut to a predetermined length (4.5 cm) through dicing using a dicing blade, and then, through similar dicing, cut into a strip shape including 12 cores described above and having a predetermined width (3.000 mm).

[PMT Ferrule]

The PMT ferrule used for manufacturing the optical connector is a PMT ferrule produced by Hakusan Manufacturing CO., Ltd. (made of a resin, color: black), which has a dimension and structure conforming to the JPCA standards.

### Example

One end portion (longitudinal end portion) of the strip-like optical waveguide manufactured as described above was fitted into an optical waveguide fitting groove of the ferrule as in the manufacturing method of the first embodiment (see FIG. 2A). Then, the position of the end portion of the optical waveguide was adjusted for positional alignment thereof, and the end portion was pressed by a glass plate, to thereby perform temporary fixing (see FIG. 2B). The laser beam L was applied from above the fitting groove to the bottom surface of the fitting groove through the optical waveguide, and the bottom surface was left for cooling, to thereby firmly fix the end portion of the above-mentioned optical waveguide to the ferrule. Note that, in this example, no adhesive was used in the temporary fixing of the above-mentioned end portion.

The applied laser beam was a near infrared laser beam having a wavelength of 940 nm, and was applied so that the focal point of the laser beam (power: 10 W) was adjusted to be a spot having a diameter of 2 mmφ on the surface of the above-mentioned fitting groove. Further, the laser beam (L) was applied with the spot moving (scanning) at a speed of 25 mm/sec in the width direction (S direction) of the optical waveguide as illustrated in FIG. 2C.

### Comparative Example

An extremely small amount of an optical thermosetting adhesive (Epotek 353ND produced by Muromachi Technos Co., Ltd.) was dripped onto the optical waveguide fitting groove of the ferrule, and on the optical waveguide fitting groove, one end portion (longitudinal end portion) of the strip-like optical waveguide manufactured in a similar manner was fitted and placed. Then, an ultraviolet ray was applied to cure the adhesive so that the above-mentioned end portion was fixed. Subsequently, an extremely small amount of the optical thermosetting adhesive was similarly dripped onto the end portion of the optical waveguide, and the lid of the ferrule was adhered and fixed. Subsequently, in order to remove the adhesive adhering to the end surface of the optical waveguide exposed at the leading end surface of the ferrule, a polishing process was performed on the leading end surface, and the optical connector of the comparative example was obtained.

Note that measurement methods used in the above-mentioned example and comparative example were as follows.

### <Measurement of Refractive Index>

Films of the forming materials (varnish) prepared for forming the cladding layers and the cores were formed on a silicon wafer by spin coating, respectively, to produce samples for measuring the refractive index. The refractive index was measured using a prism coupler (SPA-4000 manufactured by SAIRON TECHNOLOGY, INC.).

<Measurement of Heights and Widths of Cladding Layers and Cores>

The manufactured optical waveguide was cut (diced) using a dicer type cutting machine (DAD522 manufactured by DISCO Corporation), and the section was observed with a digital microscope (VHX-200 manufactured by Keyence Corporation), to thereby measure the thickness (height) and the width.

The insertion loss of the optical connector was measured in the following manner in conformity with JIS C 5961.

### <Measurement of Insertion Loss>

First, light emitted from a VCSEL (manufactured by MIKI Inc., light emission wavelength: 850 nm) as a light source was allowed to pass through a multimode optical fiber (MMF) having a diameter of 50 μmφ through a mode controller, and the light exiting the MMF was measured with a photodetector (PD) of a power meter. In this manner, calibration optical power (light quantity=I₀) before the light enters the optical waveguide was measured. Subsequently, the light exiting the above-mentioned MMF was allowed to enter the optical waveguide alone before manufacturing the optical connector (length in the longitudinal direction: 4.5 cm), and the light exiting the optical waveguide was condensed through a lens. Then, a light quantity I “before manufacturing the optical connector” was measured with the above-mentioned power meter, and a blank (control) insertion loss (optical loss) was calculated by the following expression (1).

insertion loss[dB]=−10×Log(I/I₀) (1)

Further, an insertion loss of the optical connector of the example manufactured by applying the laser beam (without polishing) and an insertion loss of the optical connector of the comparative example manufactured with an adhesive (after polishing) were measured in a similar manner.

As a result, the insertion loss of the “optical connector of the example” manufactured by applying the laser beam was 4.0 dB in the state of the optical waveguide alone before manufacturing the optical connector, and 4.0 dB in the state of the optical connector to which the ferrule was mounted. Thus, no decrease in optical loss due to the mounting of the ferrule (fixing of the end portion of the optical waveguide) was observed. In contrast, the insertion loss of the “optical connector of the comparative example” manufactured with an adhesive was 3.7 dB in the state of the optical waveguide alone before manufacturing the optical connector, and 4.7 dB in the state of the optical connector to which the ferrule was mounted. Thus, an increase by 1.0 dB in optical loss due to the mounting of the ferrule was observed.

As described above, in the manufacturing method for an optical connector, the optical waveguide can be fixed to the optical connection ferrule quickly and easily without any adverse effect on the performance (optical loss) of the optical waveguide.

In the manufacturing method for an optical connector, the optical connection ferrule can be mounted to the end portion of the optical waveguide easily in a short period of time without any decrease in performance of the signal transmission optical waveguide. Thus, the optical connector obtained by the manufacturing method is a high-quality, cost-effective optical connector suitable for optical wiring.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. A manufacturing method for an optical connector, comprising:
fitting an end portion of a transparent optical waveguide, into an optical waveguide fitting groove formed at a predetermined position of an optical connection ferrule made of a resin, the transparent optical waveguide including a core and cladding layers provided above and below the core; and
fusing and fixing the transparent optical waveguide to the optical connection ferrule by applying a laser beam having a predetermined wavelength downward from above the optical waveguide fitting groove toward the transparent optical waveguide, so that the laser beam reaches a bottom surface of the optical waveguide fitting groove.

2. The manufacturing method for an optical connector according to claim 1, wherein the laser beam comprises a near infrared laser beam having a wavelength of from 800 nm to 2,000 nm.
